(19) United States
(12) Patent Application Publication
(10) Pub. No.: US 2022/0410304 A1
(43) Pub. Date: Dec. 29, 2022

(54) 3D PRINTED ARMS FOR PINCH WELD GUN

(71) Applicant: Taylor-Winfield Technologies, Inc., Youngstown, OH (US)

(72) Inventors: Frank L. Deley, Boardman, OH (US); Rory O. McDonnell, Poland, OH (US); Brooke Renee Dyer, Cortland, OH (US)

(73) Assignee: Taylor-Winfield Technologies, Inc., Youngstown, OH (US)

(21) Appl. No.: 17/781,427

(22) PCT Filed: Dec. 18, 2020
(86) PCT No.: PCT/US2020/065895

§ 371 Date: Jun. 1, 2022

Related U.S. Application Data
(60) Provisional application No. 62/950,304, filed on Dec. 19, 2019.

(51) Int. Cl. B23K 11/31

(52) U.S. Cl. CPC B23K 11/314

(57) ABSTRACT

A weld gun having a weld arm including a 3-dimensional printed structure supporting a welding electrode. The 3-dimensional printed structure can be rapidly produced and provides the structural support for the at least one electrode. The weld arm can be manufactured quickly and are generally lighter than forged/machined arms and can be used with relatively smaller actuators than a comparable forged/machined arm.

### CROSS REFERENCE TO RELATED PATENTS AND APPLICATIONS

The present application claims priority to U.S. Provisional Patent Application Ser. No. 62/950,304, filed on Dec. 19, 2019, the entire contents being incorporated herein by reference.

### FIELD

The present exemplary embodiment relates to welding. It finds particular application in conjunction with pinch-weld guns and will be described with particular reference thereto. However, it is to be appreciated that the present exemplary embodiment is also amenable to other like applications.

### BACKGROUND

Resistance welding, capacitive discharge welding or laser welding (e.g., spot welding) is routinely employed in the manufacturing and assembly of a wide range of products, such as automobiles, appliances, etc. One type of welding device is commonly referred to as a pinch-weld gun. Pinch-weld guns typically include a pair of electrodes supported by a mount configured to move one or both electrodes from a first position (e.g., an open position) to a second position (e.g., a closed position) about a workpiece to create a weld.

Welding guns having of all shapes and sizes have been developed as their design is generally specific to a particular application. For example, welding of an automobile body requires different weld guns than welding of an appliance housing. A welding gun may be designed to be supported by any of a variety of fixtures, or to a robotic arm. A wide variety of different actuators may be used for moving the arms of the welding gun relative to one another. In some designs, one of the arms remains stationary with respect to the mount, and in others both arms move. The arm interconnection is typically referred to as a “yoke” portion. The yoke portion may be of different sizes so as to alter the spacing between the arms. The lengths of the arms may also be varied as well as the type of electrode. Various electrode types have different shapes to accommodate different applications. In addition to the above, the relative sizes and positions of virtually every component on the weld gun may be altered to suit a particular application.

In many applications, the electrodes or arms of the welding gun are custom made, typically by a casting or machining process, or a combination of both processes. For example, many current arms are machined from a solid block of copper. Lead times for producing such arms can be many weeks. Such long lead times can render assembly lines inoperative or require keeping replacement arms in stock. In addition, in larger configurations the cast and/or machined arms are heavy and require large actuators.

### BRIEF DESCRIPTION

In accordance with one aspect of the present exemplary embodiment, a weld arm includes a 3-dimensional printed structure supporting a welding electrode. The 3-dimensional printed structure can be rapidly produced and provides the structural support for the at least one electrode. Arms in accordance with the present disclosure can be manufactured much more quickly than prior art cast/machined or handmade arms, while still providing suitable performance. Arms in accordance with the present disclosure are generally lighter and can be used with relatively smaller actuators than a comparable prior art forged/machined arm.

In accordance with another aspect, a weld gun comprises at least one weld arm including a 3-dimensional printed structure, and a welding electrode supported by the 3-dimensional printed structure. The at least one weld arm can include at least one of a groove or passageway, and further the arm can further comprise a cable at least partially supported in the at least one groove or passageway and electrically coupled to the welding electrode for supplying electricity to the welding electrode.

The 3-dimensional printed structure can be made of a material having insulative properties. A cable can be provided electrically coupled to the welding electrode for supplying electricity to the welding electrode, and the cable can be a 3-dimensional printed structure. The 3-dimensional printed structure can comprise a carbon fiber or glass fiber impregnated composite material, such as copper, for example. The welding electrode can be received in a bore of the weld arm.

In accordance with another aspect, a weld arm for a weld gun comprises a 3-dimensional printed structure, and a welding electrode supported by the 3-dimensional printed structure The at least one weld arm can include at least one of a groove or passageway, and further the arm can further comprise a cable at least partially supported in the at least one groove or passageway and electrically coupled to the welding electrode for supplying electricity to the welding electrode.

The 3-dimensional printed structure can be made of a material having insulative properties. A cable can be provided electrically coupled to the welding electrode for supplying electricity to the welding electrode, and the cable can be a 3-dimensional printed structure. The 3-dimensional printed structure can comprise a carbon fiber or glass fiber impregnated composite material, such as copper, for example. The welding electrode can be received in a bore of the weld arm.

In accordance with another aspect, a method of making a weld gun arm comprises printing a 3-dimensional structure and securing a welding electrode to the 3-dimensional structure. The method can further include providing a cable in a groove or passageway of the 3-dimensional structure and electrically coupling the cable to the welding electrode. The printing can include printing a nonferrous material. The printing can include printing an insulative material for the 3-dimensional structure and printing conductive material for the cable.

### BRIEF DESCRIPTION OF THE DRAWINGS

FIG. 1 is an exemplary pinch-weld gun in accordance with the present disclosure.

FIG. 2 is a side view of another exemplary weld gun in accordance with the present disclosure;

FIG. 3 is perspective view of the weld gun of FIG. 2;

FIG. 4 is a perspective view of an exemplary weld arm in accordance with the present disclosure;

FIG. 5 is a cutaway perspective view of the weld arm of FIG. 4 showing a lattice structure having internal voids;

FIG. 6 is a perspective view of another exemplary weld arm in accordance with the present disclosure; and

FIG. 7 is a cutaway perspective view of the weld arm of FIG. 6 showing a lattice structure having internal voids.

### DETAILED DESCRIPTION

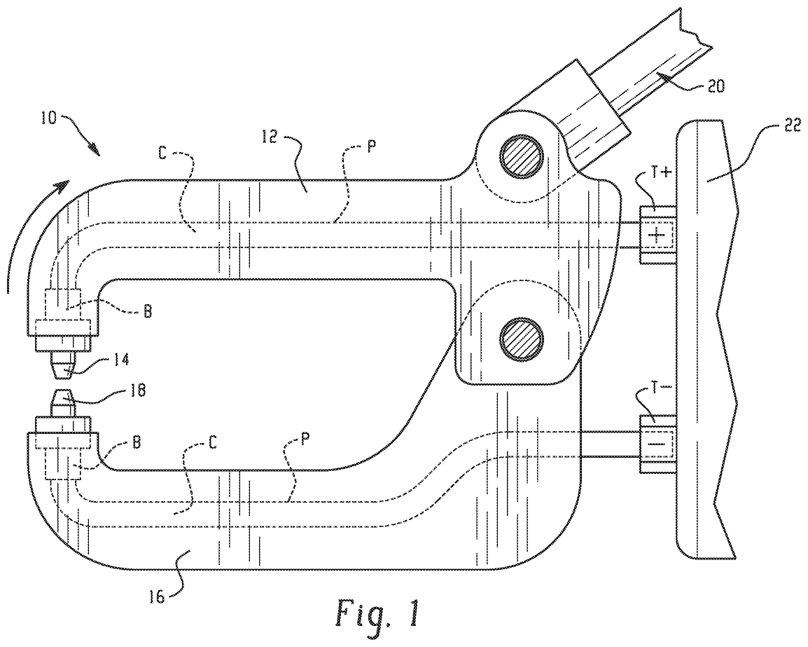

With reference to FIG. 1, an exemplary pinch-type weld gun in accordance with the present disclosure is illustrated schematically and identified generally by reference numeral 10. The weld gun 10 generally includes an upper arm 12 having an upper electrode 14, a lower arm 16 having a lower electrode 18, and an actuator 20 for selectively moving the upper arm 12 between a first and second position. The upper and lower arms 12 and 16 include air or liquid cooled cables C for coupling a respective upper or lower electrode 14/18 to a respective terminal T+/T− of a transformer 22. In the illustrated embodiment, the cables C are supported along a major portion of their lengths within respective passageways P of the upper/lower arms 12/16.

Each of the arms 12/16 is comprised of a 3D printed body. In one example, a carbon fiber or glass fiber impregnated composite material is used for printing the arms 12/16. As will be appreciated, the material will generally comprise a material having insulative properties. The arms 12/16 can be produced by a wide variety of 3D printing devices. The arms 12/16 may typically be comprised of two halves joined together about the cable C. The halves can be joined using fasteners, adhesives or via plastic welding techniques, for example. One or both halves can include a portion of the passageway such that, when assembled, the halves form the passageway. This allows for simplified installation of the cable and terminal.

In one embodiment, the cables C and electrodes 14/18 are installed to the 3D printed body after printing and curing of the 3D bodies. The cables C can be threaded through the passageways P, while the electrodes 14/18 are threaded into respective bores B of the 3D printed bodies of the arms 12/16. Both the cables C and the electrodes 14/18 can be secured in place with epoxy or by other suitable methods.

It should be appreciated that the 3D printed bodies can be generated in a wide variety of shapes and sizes to produce a weld gun 10 having a wide variety of configurations. Significantly, a weld gun 10 in accordance with the present disclosure can be rapidly manufactured because the 3D printed bodies can be produced in a matter of hours as compared to days for prior art cast assemblies. The cable and electrodes can be standardized such that a particular electrode configuration and cable gauge/length can be selected and installed in the 3D printed body after it is made.

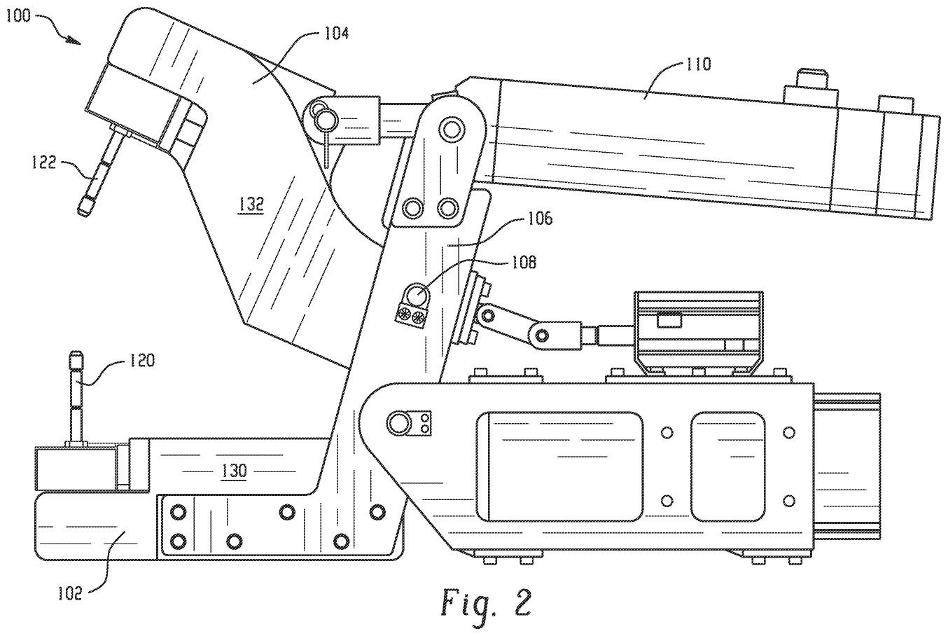

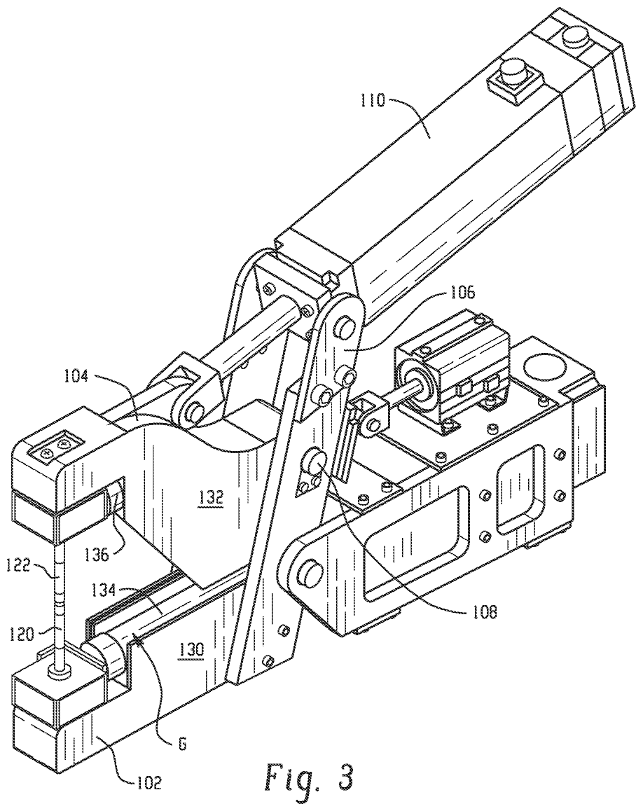

Turning to FIGS. 2 and 3, another exemplary weld gun having printed arms in accordance with the present disclosure is illustrated and identified generally by reference numeral 100. The weld gun 100 general includes a fixed, straight lower arm 102 and a movable, S-shape upper arm 104. The upper arm 104 is supported by a yoke member 106 at pivot 108. An actuator 110 is supported by the yoke member 106 and configured to move the upper arm 104 between the position shown in FIG. 2 and the position shown in FIG. 3. The particular details and features of the weld gun 100 with respect to the manner in which the arms 102 and 104 are supported and/or actuated are exemplary in nature, and it should be appreciated that aspects of the present disclosure can be used in connection with virtually any weld gun type or configuration.

The lower weld arm 102 supports a lower weld electrode 120 and the upper weld arm 104 supports an upper weld electrode 122. Each weld arm 102 and 104 includes a respective 3-dimensional printed structure 130 and 132 having a channel or groove G in which a respective cable 134 and 136 is received (See FIG. 3—only the groove G in the lower arm 102 is visible). The groove G can be U-shape in cross-section or can have any other suitable cross-sectional shape. The groove G can be open along its length or can have one or more portions that are closed (e.g., as in a passageway). The cables 134 and 136 can be secured in the grooves G using suitable adhesive and/or mechanical fasteners. The 3-dimensional printed structures 130 and 132 can include reinforcing elements such as steel or carbon fiber components embedded into the printed structures, or around which the printed structures are formed. In other embodiments, stiffening structures (e.g., lattices) can be formed during the printing of the printed structure.

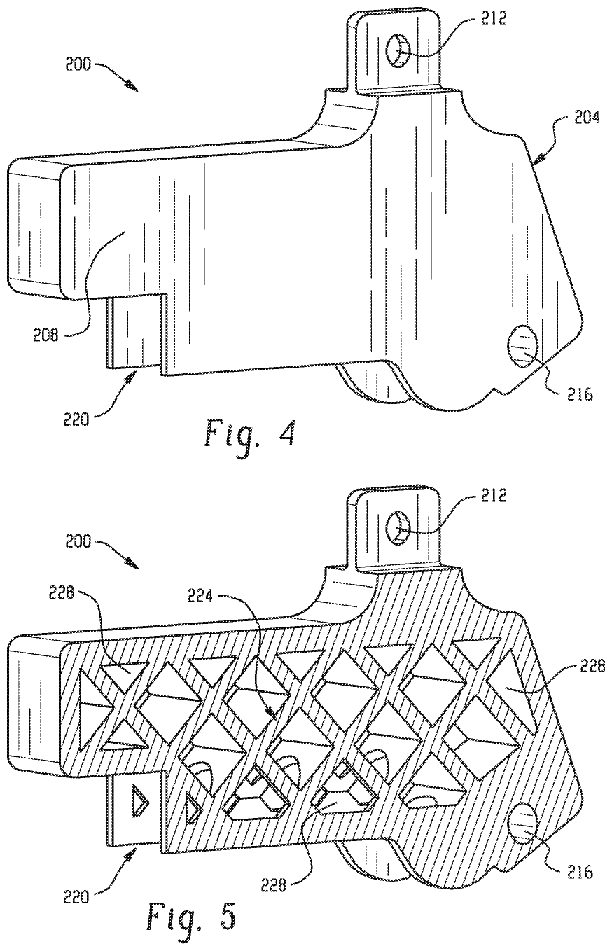

Turning to FIGS. 4 and 5, an exemplary weld arm 200 is illustrated. As noted, a wide variety of weld arm shapes are possible, and weld arm 200 illustrates just one of many possible shapes for a weld arm. The weld arm 200 includes a body 204 having an outer surface or shell 208. The weld arm 200 includes a cylinder mounting hole 212, a pivot mounting hole 216 and a wire/cable trough/recess 220. As shown in FIG. 5, the body 204 includes a lattice structure 224 having a plurality of internal voids 228. The lattice structure 224 provides stiffness to the weld arm 200 while reducing material usage and weight.

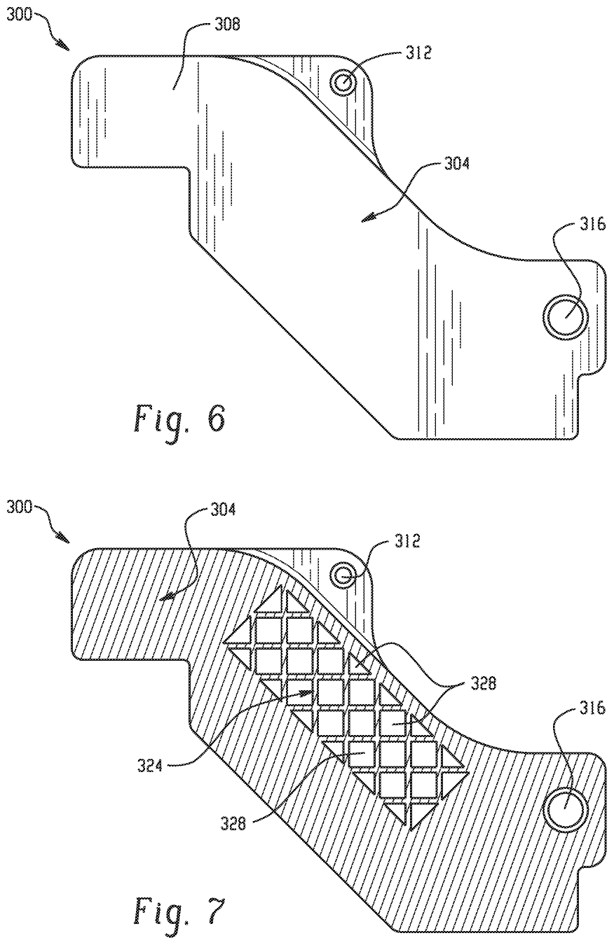

FIGS. 6 and 7 illustrate another exemplary weld arm 300. As noted, a wide variety of weld arm shapes are possible, and weld arm 300 illustrates just one of many possible shapes for a weld arm. The weld arm 300 includes a body 304 having an outer surface or shell 308. The weld arm 300 includes a cylinder mounting hole 312 and a pivot mounting hole 316. As shown in FIG. 7, the body 304 includes a lattice structure 324 having a plurality of internal voids 328. The lattice structure 324 provides stiffness to the weld arm 300 while reducing material usage and weight.

It should be appreciated that the shape, cross-sectional area, and density of the printed structures can be customized to maximize the stiffness and minimize the weight of the weld arms. In some embodiments, only the movable weld arm may include a printed structure.

In certain embodiments, one or more of the weld arms can be comprised solely of a printed non-ferrous material, such as copper. In some embodiments, a weld arm can comprise both an insulated printed structure and a conductive printed structure. For example, a weld arm can include a printed composite structure comprising a major portion of the weld arm and a printed conductive structure including an electrode. In other examples, a printed copper (or other non-ferrous material) weld arm including an electrode is contemplated. In some examples, a weld arm can be printed of one or more of nylon (e.g., nylon 66), PEKK or Arnite PET.

Certain aspects of the present disclosure can be performed and/or produced using a Tradesman Series™ P3-44 pellet extrusion machine manufactured by JuggerBot3D of Youngstown, Ohio.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A weld gun comprising:
at least one weld arm including a 3-dimensional printed structure, and a welding electrode supported by the 3-dimensional printed structure, wherein the at least one weld arm includes at least one of a groove or passageway, and further comprising a cable at least partially supported in the at least one groove or passageway and electrically coupled to the welding electrode for supplying electricity to the welding electrode.

2. (canceled)

3. The weld gun of claim 1, wherein the 3-dimensional printed structure is made of a material having insulative properties.

4. The weld gun of claim 3, further comprising a cable electrically coupled to the welding electrode for supplying electricity to the welding electrode, wherein the cable is a 3-dimensional printed structure.

5. The weld gun of claim 1, wherein the 3-dimensional printed structure comprises a carbon fiber or glass fiber impregnated composite material.

6. The weld gun of claim 1, wherein the 3-dimensional printed structure comprises a nonferrous material.

7. The weld gun of claim 7, wherein the nonferrous material includes copper.

8. The weld gun of claim 1, wherein the weld arm includes a lattice structure having at least one internal void.

9. A weld arm for a weld gun comprising:
a 3-dimensional printed structure, and a welding electrode supported by the 3-dimensional printed structure, wherein the weld arm includes at least one of a groove or passageway, and further comprising a cable at least partially supported in the at least one groove or passageway and electrically coupled to the welding electrode for supplying electricity to the welding electrode.

10. (canceled)

11. The weld arm of claim 9, wherein the 3-dimensional printed structure is made of a material having insulative properties.

12. The weld arm of claim 11, further comprising a cable electrically coupled to the welding electrode for supplying electricity to the welding electrode, wherein the cable is a 3-dimensional printed structure.

13. The weld arm of claim 9, wherein the 3-dimensional printed structure comprises a carbon fiber or glass fiber impregnated composite material.

14. The weld arm of claim 9, wherein the 3-dimensional printed structure comprises a nonferrous material.

15. The weld arm of claim 14, wherein the nonferrous material includes copper.

16. The weld arm of claim 9, wherein the weld arm includes a lattice structure having at least one internal void.

17. A method of making a weld gun arm comprising:
printing a 3-dimensional structure including a lattice structure having at least one internal void;
securing a welding electrode to the 3-dimensional structure; and
providing a cable in a groove or passageway of the 3-dimensional structure and electrically coupling the cable to the welding electrode.

18. (canceled)

19. The method claim 17, wherein the printing includes printing a nonferrous material.

20. The method of claim 17, further wherein the printing includes printing an insulative material for the 3-dimensional structure and printing conductive material for the cable.
